(19) United States
(12) Patent Application Publication
(10) Pub. No.: US 2024/0204417 A1
(43) Pub. Date: Jun. 20, 2024

(54) SLOT ANTENNA ARRAY

(71) Applicant: SWISSto12 SA, Renens (VD) (CH)

(72) Inventors: Esteban Menargues Gomez, Préverenges (CH); Lionel Simon, Lausanne (CH); Antoine Calleau, Lausanne (CH)

(21) Appl. No.: 18/259,165

(22) PCT Filed: Dec. 22, 2021
(86) PCT No.: PCT/IB2021/062221

§ 371 Date: Jun. 23, 2023

(30) Foreign Application Priority Data
Dec. 24, 2020 (FR) 2014146

(51) Int. Cl. H01Q 21/00; H01Q 13/10

(52) U.S. Cl. CPC H01Q 21/005; H01Q 13/10; H01Q 21/0087

(57) ABSTRACT

Antenna array including: a plurality of juxtaposed elementary antennas, each elementary antenna including a waveguide one face of which is provided with an array of slots in order to radiate outside the waveguide at least part of the electromagnetic energy in the waveguide; a coupling waveguide for individually feeding each antenna element from a face opposite the face provided with radiating slots, wherein the antenna is a component resulting from additive manufacturing, a section of the slots is either non-rectangular or rectangular with sides not parallel to a longitudinal direction of the waveguides, and the coupling waveguide has irises and/or steps on its inner side so as to control the phase and/or amplitude of the signals in the different coupling slots.

### TECHNICAL FIELD

The present invention relates to the field of slot antennas and the manufacture of such antennas.

### BACKGROUND ART

Slot antenna arrays consist of a metal surface, usually a flat plate, with an array of cut slots that radiate electromagnetic waves. The shape, size and arrangement of the slots determine the radiation pattern for a given frequency. The precise shape and arrangement of the slots reduces cross-polarization problems between slots. At microwave frequencies, the slots are usually provided in one of the walls of a waveguide that conducts electromagnetic energy to the slots in emission or from the slots in reception.

Several slot antennas can be placed side by side to form a slot antenna array. Such an array allows for better control of the phase and amplitude of the signals emitted from each slot.

Such antennas and antenna arrays are used in particular in aircraft radar antennas, including airborne weather radar antennas and some UHF television transmitting antennas, and in particular marine radar antennas.

Slot antennas are compact and easier to mass produce than other types of antennas. However, the precise machining of a large number of slots adds to the cost of these antennas. There is therefore a need to further reduce the cost of this type of antenna. Furthermore, it is desirable to be able to manufacture low cost antennas, and arrays of such antennas, in small or large batches or with custom dimensions or slot arrays.

U.S. Pat. No. 3,363,253 relates to a slot antenna array comprising a plurality of juxtaposed elementary antennas, each of which elementary antennas comprises a waveguide having a face provided with pairs of radiating slots arranged along the length of the waveguide. A coupling waveguide feeds the individual elementary antennas.

Additive manufacturing has already been employed for waveguide manufacturing and in particular allows waveguides to be manufactured in small and large batches and with custom dimensions. Waveguides are typically 3D printed with the longitudinal axis, along the direction of signal propagation, vertical, thus avoiding the need to print cantilevered waveguide walls.

This additive manufacturing method is however not well suited for the manufacture of slotted antennas, as each slot has a vault portion which is difficult to print when the antenna is in a vertical position.

US 2018/366800 A1 relates to an antenna array, each of the antennas comprising juxtaposed waveguides with radiating slots on one side. These antennas are served by a coupling waveguide. In particular, this document discloses additive manufacturing of some or all of the antenna array.

Document GUENNOU-MARTIN A ET AL: “Design and manufacturing of a 3-D conformal slotted waveguide antenna array in Ku-band based on Direct Metal Laser Sintering”, 2016 IEEE CONFERENCE ON ANTENNA MEASUREMENTS & APPLICATIONS (CAMA), IEEE, Oct. 23, 2016, also relates to an antenna array comprising juxtaposed waveguides, one face of which is provided with slots. The juxtaposed waveguides are fed by a coupling waveguide. This article deals in particular with the additive manufacturing of such slotted antenna arrays. An aim of the present invention is therefore to provide a more economical slotted antenna array, in particular for manufacturing in small series with customized dimensions, or also in large series.

Another purpose of the present invention is to provide a new and more economical method of slot antenna array fabrication.

### BRIEF SUMMARY OF INVENTION

It is therefore an aim of the present invention to provide a more economical slot antenna array, especially for small batch production with customized dimensions, or also for large batch production.

Another purpose of the present invention is to provide a new and more economical process for manufacturing a slot antenna array.

According to the invention, these goals are achieved in particular by means of slot antenna array comprising:
a plurality of juxtaposed elementary antennas, each elementary antenna comprising a waveguide, one face of which is provided with radiating slots in order to radiate outside the waveguide at least part of the electromagnetic energy in said waveguide,
a coupling waveguide for individually feeding each said elementary antenna from a face opposite to said face provided with radiating slots, characterized in that
said antenna array is a component resulting from additive manufacturing
and in that a section of said radiating slots is either non-rectangular or rectangular with sides not parallel to a longitudinal direction of said waveguides
and in that the coupling waveguide has irises and/or steps on its inner side so as to control the phase and/or amplitude of the signals in the different coupling slots. The signal introduction slot allows the electromagnetic signal to be introduced into, or extracted from, the coupling waveguide.

The non-rectangular cross-section of the slots gives the designer more freedom to make slots that can be printed in additive manufacturing, i.e., slots that do not need to be machined by material removal in one side.

In particular, this non-rectangular cross-section makes it possible to produce slots whose upper portion during printing is less likely to collapse.

This cross-section may be, for example, oval, elliptical, triangular, or polygonal with at least five sides.

The cross-section of the slots is advantageously hexagonal. This allows for a vaulted portion of the slot during printing that is sufficiently oblique to the horizontal so as not to collapse.

The cross-section of the slots can be pentagonal.

The larger dimension of the slots may extend parallel to the longitudinal direction of said waveguides. This allows the antenna array to be additively printed with the waveguides oriented vertically and the slots oriented vertically, and thus reduce the risk of collapsing.

The largest dimension of the slots can extend obliquely to the longitudinal direction of said waveguides. This allows the antenna array to be manufactured by additive printing with the waveguides whose slots, even if rectangular, do not have a horizontal cantilever section during printing, and are therefore less likely to collapse.

The coupling waveguide advantageously extends in a direction perpendicular to that of the elementary antennas.

The coupling waveguide is advantageously connected to each elementary antenna through at least one coupling slot that allows electromagnetic energy to be transmitted between the coupling waveguide and that elementary antenna.

The cross-section of the coupling slots may be either non-rectangular or rectangular with sides non-parallel to the longitudinal direction of said waveguides.

The cross-section of the coupling slots may be, for example, oval, elliptical, triangular, or polygonal with at least five sides.

The largest dimension of said coupling slots may extend obliquely to the longitudinal direction of said waveguides.

The coupling slots are preferably alternately oriented at +45° and −45° with respect to the longitudinal direction of said waveguides. This oblique orientation facilitates 3D printing fabrication by reducing cantilevered portions. Different tilt angles, between 0° and 90°, can be provided. Tests and simulations have shown that alternating positive and negative slot inclinations improve coupling performance.

Other geometric shapes may be used for the coupling slots, including, for example, diamond-shaped slots or circles.

The irises and/or steps are preferably oriented parallel to the longitudinal axis of said elementary antennas, so as to facilitate their additive manufacturing.

For this purpose, said irises preferably have a non-rectangular iris section.

The cross-section of said coupling waveguide is also preferably non-rectangular, for example oval, elliptical, trapezoidal, hexagonal, or polygonal with at least 5 sides, to facilitate its additive manufacturing.

The electromagnetic signal may be introduced into, or extracted from, the coupling waveguide through a signal introduction slot.

This signal introduction slot advantageously has a non-rectangular section, preferably a hexagonal section.

The antenna array may comprise an additively manufactured metallic or synthetic core, and a conductive coating on the core.

Another object of the invention is a method of manufacturing a slot antenna array comprising an additive manufacturing step, said elementary antennas being oriented with their longitudinal axis at an angle between 0° and 45° during this step, the slots having a non-rectangular cross-section, for example a hexagonal cross-section.

### BRIEF DESCRIPTION OF THE FIGURES

Examples of embodiments of the invention are shown in the description illustrated by the attached figures in which:

FIG. 1 illustrates a perspective view from the front face of a slot antenna array according to the present invention

FIG. 2 illustrates a perspective view from the rear face of a slot antenna array according to the present invention

FIG. 3 illustrates a cross-sectional view of a slot antenna array according to the present invention, the view being oriented along line 3-3- in FIG. 2.

FIG. 4 illustrates a perspective view of a portion of a slot antenna array according to the present invention, the portion being cut along the line 4-4- in FIG. 2.

FIG. 5 illustrates a perspective view of the rear portion of a slot antenna array according to the present invention.

FIG. 6 illustrates a perspective view of the front part of a slot antenna array according to the present invention.

### EXAMPLE(S) OF EMBODIMENT OF THE INVENTION

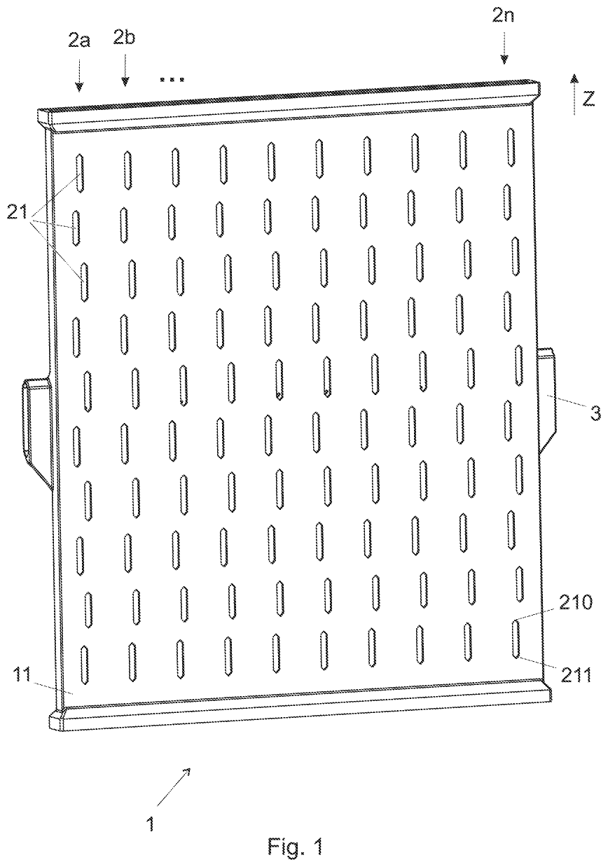

FIG. 1 illustrates a view of the front face 11 of a slot antenna array 1 according to the present invention. The array comprises a plurality of elementary antennas 2a, 2b, . . . , 2n juxtaposed along the z-axis, each elementary antenna 2 comprising n radiating slots arranged in columns. In the illustrated example, the array 1 comprises n=10 elementary antennas, each antenna comprising 10 radiating slots forming a column. The odd radiating slots are laterally offset from the even radiating slots of the same antenna.

In transmission, this antenna array 1 is intended to transmit an electromagnetic signal through each radiating slot, the signals transmitted by the different slots combining. On reception, the signals received through the different radiating slots combine in each elementary antenna 2 and then between elementary antennas.

The antenna array 1 can be intended for example to form a meteorological radar antenna for example in the nose of an aircraft.

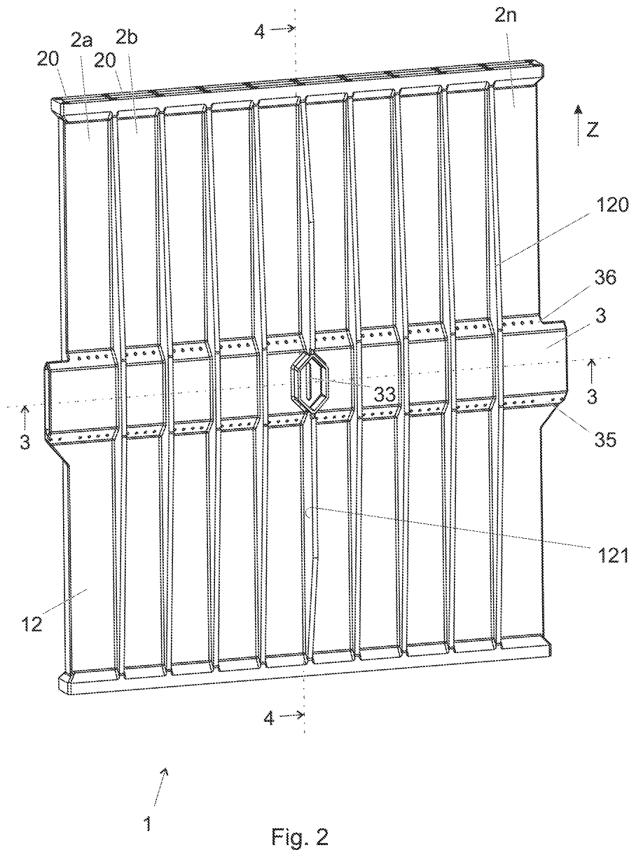

FIG. 2 illustrates a view of the rear face of the antenna array 1. The element 3 and a coupling waveguide that crosses all elementary antennas 2a-2n to feed each of these elementary antennas individually from the rear face 12 opposite the front face provided with slots, or to receive and combine the electromagnetic signals in these different elementary antennas. The figure also allows to see the openings 20 passing through each elementary antenna 2 along the longitudinal axis z, and forming a waveguide connected to the slots 21 on the front face 11. The elements 120 are reinforcing and stiffening ribs extending parallel to the longitudinal axis of the waveguides on the rear face 12. The symmetrical rib 121 has a greater height than the ribs 101 and supports the opening 33. This aperture 33 constitutes a signal introduction slot for introducing an electromagnetic signal to be transmitted into the coupling waveguide 3, and/or for recovering the signal received in this waveguide.

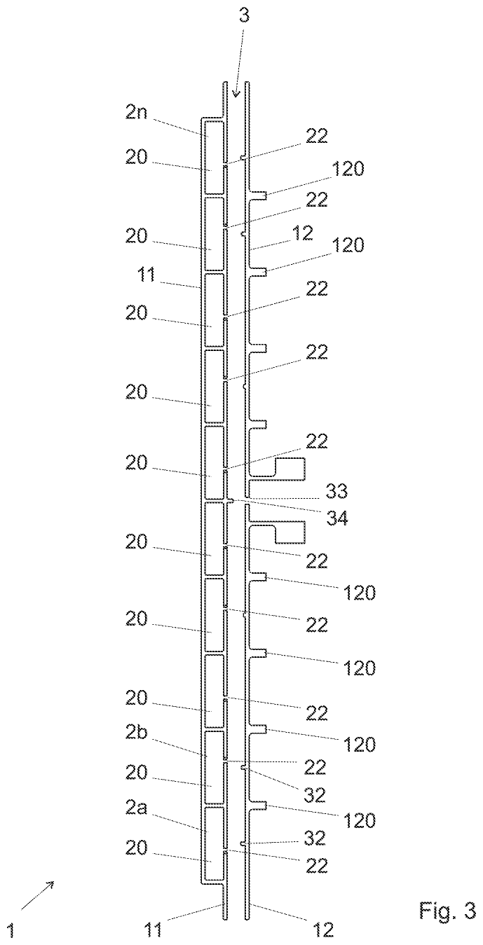

FIG. 3 is a cross-sectional view of the array 1 along the line 3-3 in FIG. 2. As one can see, the coupling waveguide 3 is individually connected to the waveguide 20 of each of the elementary antennas 2 by means of a coupling slot 22. A T-junction 34 is provided on the inner side of the coupling waveguide 3 opposite to the slot 33 so that the electromagnetic energy injected through this slot is distributed on both sides of this junction. The elements 32 are steps on the face of the coupling waveguide 3 that control the phase and amplitude of the signals in each coupling slot 22.

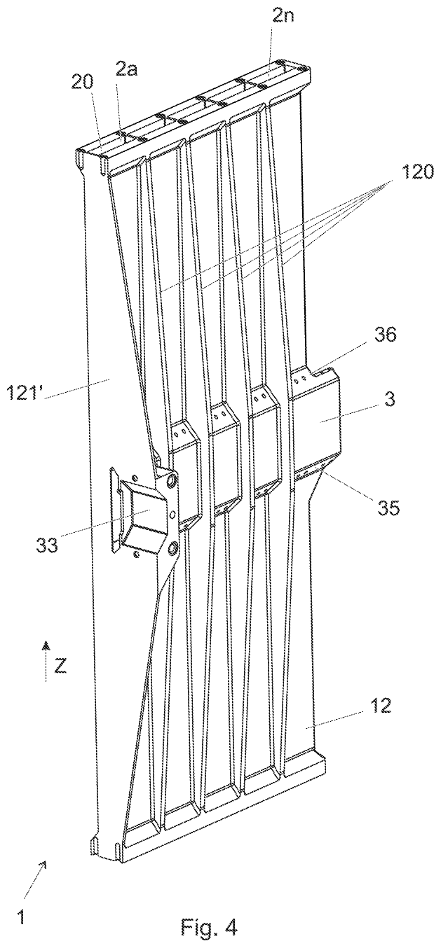

FIG. 4 is another cross-sectional and perspective view of the slot antenna array 1 along line 4-4 of FIG. 2. In this Figure, the signal introduction slot 33 is formed in a rib 121′ whose asymmetric shape is modified with respect to that of FIG. 3.

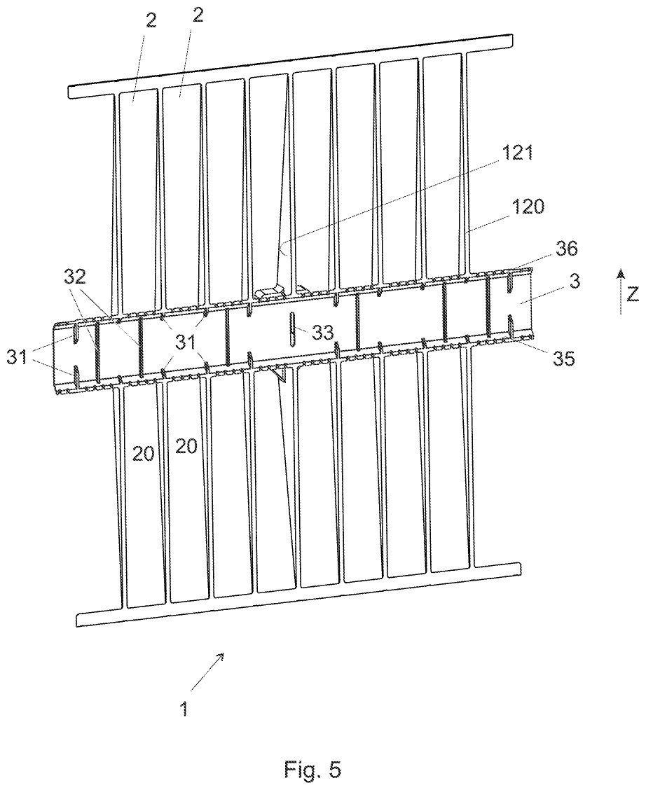

FIG. 5 is another cross-sectional and perspective view of the rear half of the slot antenna array 1. In this Figure, the signal introduction slot 33 penetrates from the rear face 12 into the coupling waveguide 3. The steps 32 and the irises 31 provided on the walls of this channel allow to control the amplitude and the phase of the signals radiated from this waveguide 3.

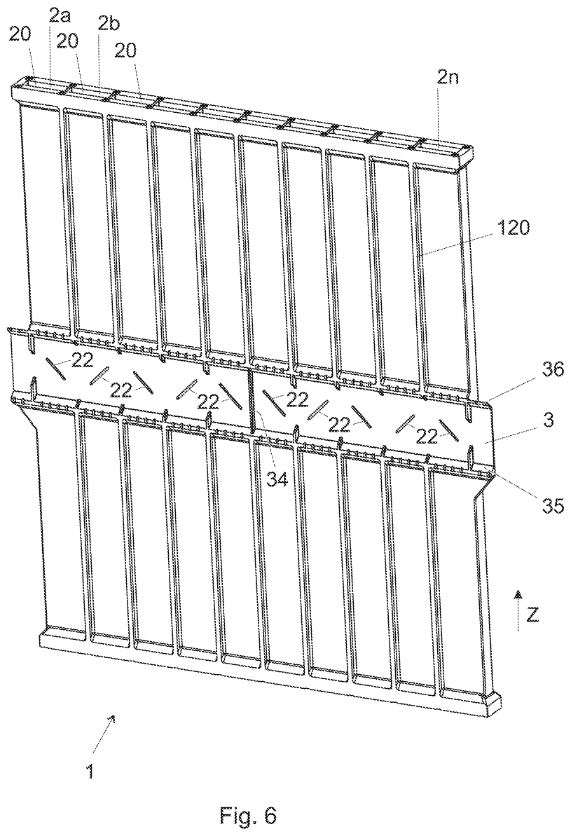

FIG. 6 is another cross-sectional and perspective view of the front half of the slot antenna array 1. In this Figure, the T-junction 34 opposite to the signal introduction slot 33, as well as the coupling slots 22 between the coupling waveguide 3 and the waveguides 20, are observed. These slots are alternately inclined at plus and minus 45° with respect to the longitudinal z direction of the waveguides 20.

The antenna array 1 is obtained by additive manufacturing, for example by 3D printing, for example by stereolithography. Advantageously, it comprises a core not illustrated made of metal, or possibly of synthetic or ceramic material, and a coating obtained by electroplating at least on the internal faces of this core, i.e. on the walls of the waveguides, and preferably on all the surfaces of the array. The antenna array can be monolithic.

In one embodiment, the array is obtained using a process comprising a step of printing the core by orienting the elementary antennas 2 vertically, i.e. parallel to the z-axis. This arrangement avoids the risk of collapse of the waveguide walls during 3D printing.

In an alternative embodiment, the array is obtained using a process comprising a step of printing the core by orienting the elementary antennas 2 so that their longitudinal axis forms an angle greater than 0° and less than or equal to 45° with the vertical printing axis. This arrangement avoids the risk of the side walls of the slots collapsing during 3D printing. Preferably, the largest dimension of the slots extends parallel to the printing direction so that the largest side walls of the slots are vertical, even if the slots are not parallel to the longitudinal axis of the elementary antennas.

The radiating slots 21 (FIG. 1) have a cross-section 21, which allows them to be made by 3D printing without the need for machining and without the risk of the upper portion 210 (vault) collapsing during printing. In a preferred embodiment, this upper portion forms a triangle, as does the lower portion 211, so that the slots 21 have a hexagonal cross-section. A pentagonal cross-section, with a straight lower portion, can also be imagined.

The coupling slots 22 (FIG. 6) are inclined at + or −45° with respect to the horizontal during printing, which also avoids the risk of their upper ceiling collapsing during their printing.

The signal introduction slot 33 is preferably also non-rectangular in cross-section, e.g., oval, elliptical, or polygonal with at least five sides, e.g., hexagonal, to allow it to be printed in a vertical position.

Other portions that cantilever during printing are also made with slants, i.e., non-horizontal surfaces that could collapse. This is particularly the case for the lower 35 and upper 36 walls of the coupling waveguide 3, which thus has a trapezoidal cross-section. This is also the case for the lower portions of the irises 31.

### REFERENCE NUMERALS

1 Slot antenna array
11 Front face
12 Rear face
120 Reinforcing ribs on the rear side
121 Rib supporting the signal input slot.
2 Elementary antenna
20 Waveguide
21 Radiating slots
210 Upper portion of slots 21 (vault)
211 Lower portion of slot 21 (floor)
22 Coupling slot
3 Coupling waveguide
31 Iris
32 Steps
33 Signal introduction slot
34 T-junction
35 Lower wall of the coupling waveguide
36 Upper wall of the coupling waveguide
z Longitudinal direction of the waveguides

What is claimed is:

1. Slot antenna array comprising:
a plurality of juxtaposed elementary antennas, each elementary antenna comprising a waveguide, one face of which is provided with radiating slots in order to radiate outside the waveguide at least part of the electromagnetic energy in said waveguide
a coupling waveguide for individually feeding each said elementary antenna from a face opposite to said face provided with radiating slots,
wherein
said antenna array is a component resulting from additive manufacturing,
a cross-section of said radiating slots is either non-rectangular or rectangular with sides not parallel to a longitudinal direction of said waveguides
and in that the coupling waveguide has irises and/or steps on its inner face so as to control the phase and/or amplitude of the signals in the different coupling slots.

2. The antenna array according to claim 1, wherein said cross-section is non-rectangular and is oval, elliptical, circular, diamond shaped, or polygonal with at least five sides.

3. Antenna array according to claim 2, wherein said cross-section is hexagonal.

4. Antenna array according claim 1, wherein the largest dimension of said radiating slots extends parallel to the longitudinal direction of said waveguides.

5. The antenna array according to claim 1, wherein the coupling waveguide is connected to each elementary antenna through a coupling slot.

6. The antenna array of claim 5, wherein the cross-section of the coupling slots is either non-rectangular or rectangular with sides not parallel to the longitudinal direction of said waveguides.

7. The antenna array of claim 6 wherein the cross-section of the coupling slots is oval, elliptical, triangular, or polygonal with at least five sides.

8. The antenna array of claim 5, wherein the largest dimension of said coupling slots extends obliquely to the longitudinal direction of said waveguides.

9. The antenna array of claim 8, wherein the coupling slots are oblique and alternately oriented at a positive and negative angle to the longitudinal direction of said waveguides.

10. The antenna array according to claim 1, wherein said irises and/or steps are oriented parallel to the longitudinal axis of said elementary antennas.

11. The antenna array according to claim 1, wherein said irises have a non-rectangular cross-section.

12. The antenna array according to claim 1, wherein the cross-section of said coupling waveguide is oval, elliptical, trapezoidal or polygonal with at least 5 sides.

13. The antenna array according to claim 1, wherein said coupling waveguide comprises a signal introduction slot.

14. The antenna array of claim 13, wherein said signal introduction slot has an oval, elliptical, or polygonal cross-section with at least five sides.

15. An antenna array according to claim 1, comprising a core resulting from said additive manufacturing and a coating layer on said core.

16. A method of manufacturing an antenna array according to claim 1, comprising an additive manufacturing step, said elementary antennas being oriented with their longitudinal axis forming an angle between 0° and 45° during this step.
